(19) United States
(12) Patent Application Publication
(10) Pub. No.: US 2013/0086673 A1
(43) Pub. Date: Apr. 4, 2013

(54) TECHNIQUES FOR SECURELY UNLOCKING A TOUCH SCREEN USER DEVICE

(71) Applicants: David Putterman, Cambridge, MA (US); John Russell, Shirley, MA (US); Brian Glanville, Shirley, MA (US); Konstas Yannakopoulos, Bolton, MA (US); Dhiren Patel, Berlin, MA (US)

(72) Inventors: David Putterman, Cambridge, MA (US); John Russell, Shirley, MA (US); Brian Glanville, Shirley, MA (US); Konstas Yannakopoulos, Bolton, MA (US); Dhiren Patel, Berlin, MA (US)

(73) Assignee: Cisco Technology, Inc., San Jose, CA (US)

(21) Appl. No.: 13/248,299

(22) Filed: Sep. 29, 2011

(51) Int. Cl. G06F 21/20; G06F 3/041

(52) U.S. Cl. 726/19; 345/173

(57) ABSTRACT

Techniques are provided for detecting a sequence of contact or interaction instances initiated by a user on a surface of an interface unit of a user device. Each contact instance comprises one or more points of contact between the user and the surface of the interface unit, while each interaction instance comprises one or more points of activation with respect to the surface of the interface unit. The sequence of contact instances or interaction instances initiated by the user is then compared to stored information to determine whether the sequence of contact instances or interaction instances matches the stored information. If the sequence of contact instances or interaction instances matches the stored information, access is granted to the user device or to a device or system associated with the user device.

### TECHNICAL FIELD

The present disclosure relates to unlock mechanisms for touch screen user devices.

### BACKGROUND

User devices such as phones, tablet computers, etc., are configured with touch screen user interfaces that enable a user to program a password or code that can later be used to unlock the device. These user devices have several variations of unlock mechanisms, including entering the password or code password or sliding fingers in a specific pattern across the screen. However, due to the nature of the touch screen user interface itself, there is a possibility that a password can be derived by visually observing finger marks on the screen.

### BRIEF DESCRIPTION OF THE DRAWINGS

FIG. 1 shows an example user device comprising a display and an interface unit configured to receive a plurality of contact instances or interaction instances from a user for purposes of unlocking the device.

FIG. 2 is an example block diagram of the user device configured to detect a sequence of contact instances or interaction instances and to compare the detected contact instances or interaction instances with stored information to unlock the user device.

FIG. 3 is a flow chart depicting operations of a contact detection and sequence matching logic executed in the user device for detecting contact instances.

FIG. 4 is a flow chart depicting operations of the contact detection and sequence matching logic for determining whether the detected contact instances match the stored information in order to unlock the user device.

FIG. 5A shows an example of “touch sequence” contact instances or interaction instances received from the user.

FIG. 5B shows an example of a “rhythm sequence” of contact instances or interaction instances received from a user.

FIG. 5C shows an example of an “add sequence” of contact instances or interaction instances received from a user.

FIG. 6 is a flow chart depicting operations of the contact detection and sequence matching logic for detecting interaction instances.

FIG. 7 is a flow chart depicting operations of the contact detection and sequence matching logic for determining whether detected interaction instances match the stored information in order to unlock the user device.

### DESCRIPTION OF EXAMPLE EMBODIMENTS

Overview

Techniques are provided for detecting a sequence of contact or interaction instances initiated by a user on a surface of an interface unit of a user device. Each contact instance comprises one or more points of contact between the user and the surface of the interface unit, while each interaction instance comprises one or more points of activation with respect to the surface of the interface unit. The sequence of contact instances or interaction instances initiated by the user is then compared to stored information to determine whether the sequence of contact instances or interaction instances matches the stored information. If the sequence of contact instances or interaction instances matches the stored information, access is granted to the user device.

### Example Embodiments

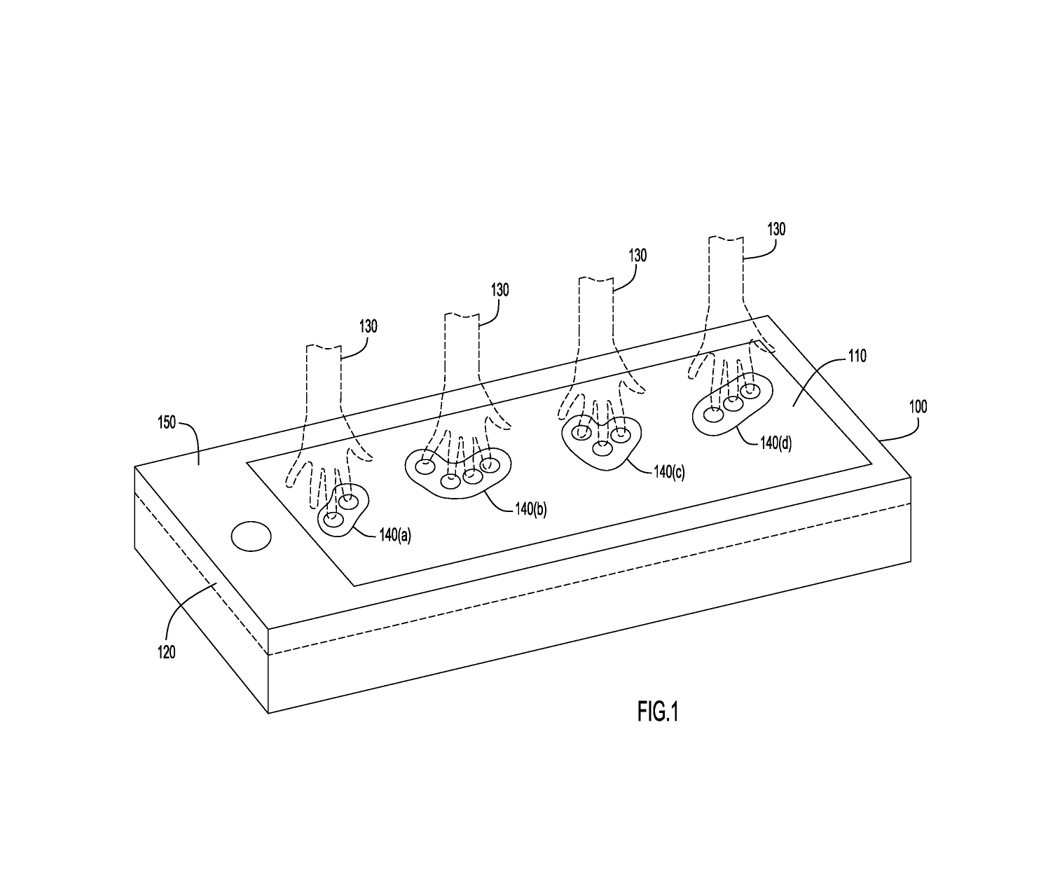

FIG. 1 shows an example of a user device 100 having an interface unit 110 and a display 120. The user device 100 may be any device with an interactive interface unit 110 that is configured to receive a plurality of contact (“touch”) instances or interaction instances from a user. In one example, the user device 100 may be a mobile device with the interface unit 110. In another example, the user device 100 may be a vault or safe with an interactive interface unit configured, e.g., to allow a user to unlock the safe via a sequence of contacts or interaction on the interface unit 110, as described herein. The user device 100 may be any device that employs an interface unit 110, e.g., touch screen interface, to obtain access to or usage of a feature or function of the device.

As shown in FIG. 1, a user 130 may contact (e.g., via a finger touch, a stylus, etc.) the interface unit 110 at multiple locations to create multiple contact instances, shown at reference numerals 140(a)-140(d). The interface unit 110 may also be configured to receive a plurality of interaction instances from the user 130, wherein the user 130 may gesture or imitate a touch without actually making contact with the interface unit 110 to create the interaction instances. These gestures or imitations may be referred to as “points of activation.” For example, the interface unit 110 may interface with an infrared array sensor or gesture sensing technology to detect gestures or touch imitations/simulations from the user 130 to create multiple interaction instances on the interface unit 110. Reference numerals 140(a)-140(d) in FIG. 1 may also represent these interaction instances on the interface unit 110.

In general, as shown in FIG. 1, the interface unit 110 of the user device 100 resides on a top surface 150 of the user device 100. The display 120, for example, resides below the interface unit 110 along a plane substantially similar to the top surface 150 and the interface unit 110. Thus, when the user 130 interacts with the user device 100 (e.g., when the user device 100 is unlocked), the user 130 may see images (e.g., mobile application icons) on the display 120 through the interface unit 110, and may interact with the application icons on the display 120 via the interface unit 110. This configuration, however, is an example, and it should be appreciated that the interface unit 110 and the display 120 may be arranged in other configurations.

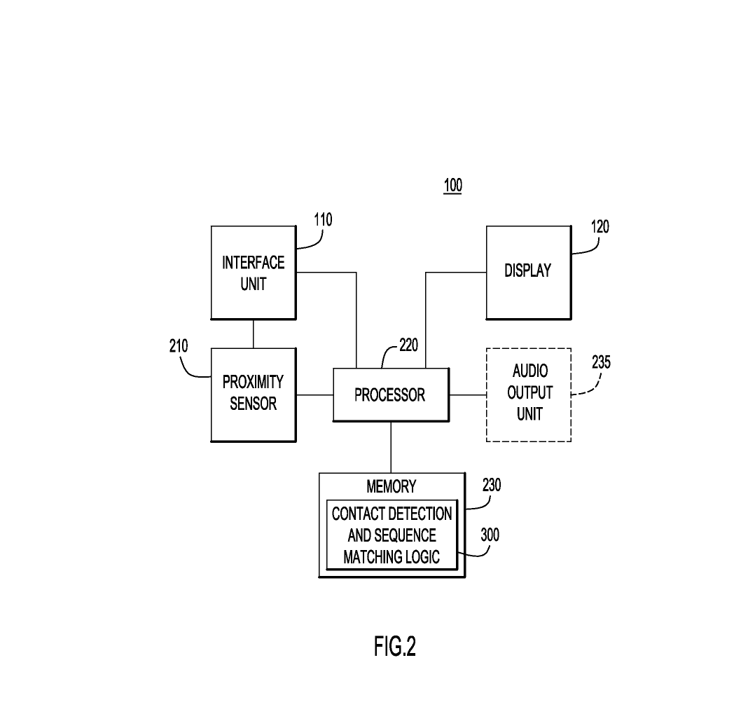

Turning to FIG. 2, an example block diagram of the user device 100 is now described. The user device 100 comprises an interface unit 110, a display 120, a proximity sensor 210, a processor 220 and a memory 230. The interface unit 110, display 120, proximity sensor 210 and memory 230 are coupled to the processor 220. The interface unit 110, as described above, is configured to receive one or more contact (touch) instances or interaction instances from the user 130. The display 120, also described above, is configured to display images that are associated with the user device 100 (e.g., icons for mobile applications of the user 100).

The proximity sensor 210 is a device configured to, for example, detect a gesture or touch imitation/simulation by the user 130. As described above in connection with FIG. 1, the interface unit 110 may be configured to receive interaction instances from the user 130 when the user 130 does not initiate a physical touch with the interface unit 110. The proximity sensor 210, for example, may be an infrared array sensor or other sensor configured to detect the proximity of the user 130 to the interface unit 110.

FIG. 2 also shows an option audio output unit 235 configured to interface with the processor 220. The audio output unit 235 may be any device configured to emit audio, for example, to prompt the user 130 to enter a sequence of contact instances or interaction instances to unlock the user device 100.

The processor 220 is a microprocessor or microcontroller that is configured to execute program logic instructions (i.e., software) for carrying out various operations and tasks described herein. For example, the processor 220 is configured to execute contact detection and sequence matching logic 300 that is stored in the memory 230 to detect a sequence of contact instances or interaction instances and to compare the detected contact instances or interaction instances with stored information to unlock the user device 100. The memory 230 may comprise read only memory (ROM), random access memory (RAM), magnetic disk storage media devices, optical storage media devices, flash memory devices, electrical, optical or other physical/tangible memory storage devices.

The functions of the processor 220 may be implemented by logic encoded in one or more tangible computer readable storage media (e.g., embedded logic such as an application specific integrated circuit, digital signal processor instructions, software that is executed by a processor, etc.), wherein the memory 230 stores data used for the operations described herein and stores software or processor executable instructions that are executed to carry out the operations described herein.

The contact detection and sequence matching logic 300 may take any of a variety of forms, so as to be encoded in one or more tangible computer readable memory media or storage device for execution, such as fixed logic or programmable logic (e.g., software/computer instructions executed by a processor), and the processor 220 may be an application specific integrated circuit (ASIC) that comprises fixed digital logic, or a combination thereof.

For example, the processor 220 may be embodied by digital logic gates in a fixed or programmable digital logic integrated circuit, which digital logic gates are configured to perform contact detection and sequence matching logic 300. In general, the contact detection and sequence matching logic 300 may be embodied in one or more computer readable storage media encoded with software comprising computer executable instructions and when the software is executed operable to perform the operations described herein for the process logic 300.

As described above, the user device 100 is configured to detect a sequence of contact instances or interaction instances initiated by the user 130 on the surface of the interface unit 110. The sequence of contact instances or interaction instances is compared to stored information to determine whether the sequence matches the stored information. For example, when the user 130 has access to the user device 100 (e.g., when the user device 100 is “unlocked”), the user 130 may initiate a sequence of contact instances or interaction instances with the interface unit 110 to serve as an unlock sequence. In other words, the user 130 may set a security password or code for the user device 100 by setting the unlock sequence. For example, as described herein, the unlock sequence may be a series of touches on the interface unit 110, e.g., a “4-3-4-1” sequence comprising four contact instances: (1) four simultaneous touches; (2) three simultaneous touches; (3) four simultaneous touches; and (4) one touch. The unlock sequence may be stored as information (e.g., a code) in the memory 230, and later, after the user device 100 is locked, the user 130 would need to enter the correct unlock sequence in order to be granted access to the user device 100.

When the user device 100 is locked, the user 130, seeking to unlock the user device 100, may initiate a sequence of contact instances or interaction sequences on the surface of the interface unit 110. After the interface unit 110 detects the sequence of contact instances or interaction instances initiated by the user 130 to attempt to unlock the user device 100, a code associated with the sequence of contact instances or interaction instances is compared to a stored code associated with the unlock sequence to determine whether the user device 100 should be unlocked. For example, if the user 130 enters the 4-3-4-1 sequence, in the example described above, the user device 100 will be unlocked.

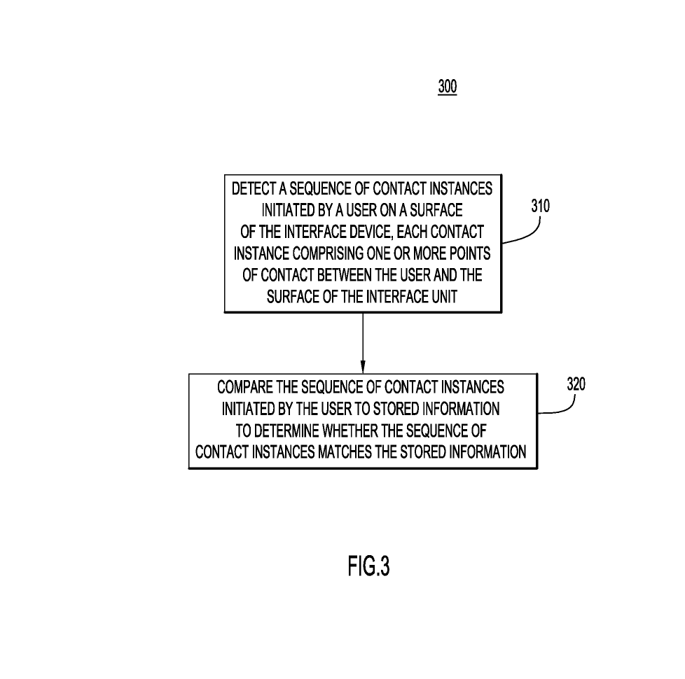

Reference is now made to FIG. 3, which shows a flow chart depicting the comparison operations of the contact detection and sequence matching logic 300 for detecting contact instances. At 310, a sequence of contact instances initiated by the user 130 is detected on a surface of the interface unit 110. Each contact instance may comprise one or more points of contact between the user 130 and the surface of the interface unit 110. For example, the user 130 may touch (e.g., using one or more fingers) the interface unit 110 to initiate a contact instance. In one example, if the user 130 touches four fingers on the surface of the interface unit 110 and later, after a predetermined period of time, touches two fingers on the surface of the interface unit 110, the processor 210 of the interface unit 110 will detect a “4-2” sequence. It should be appreciated that the user 130 may use other mechanisms to touch the interface unit 110. For example, the user 130 may use a stylus or other touching device to make contact with the interface unit 110. After detecting a sequence of contact instances initiated by the user 130, the sequence of contact instances initiated by the user 130 is compared to stored information associated with an existing unlock sequence or password. This comparison is used to determine whether the detected sequence of contact instances matches the stored information.

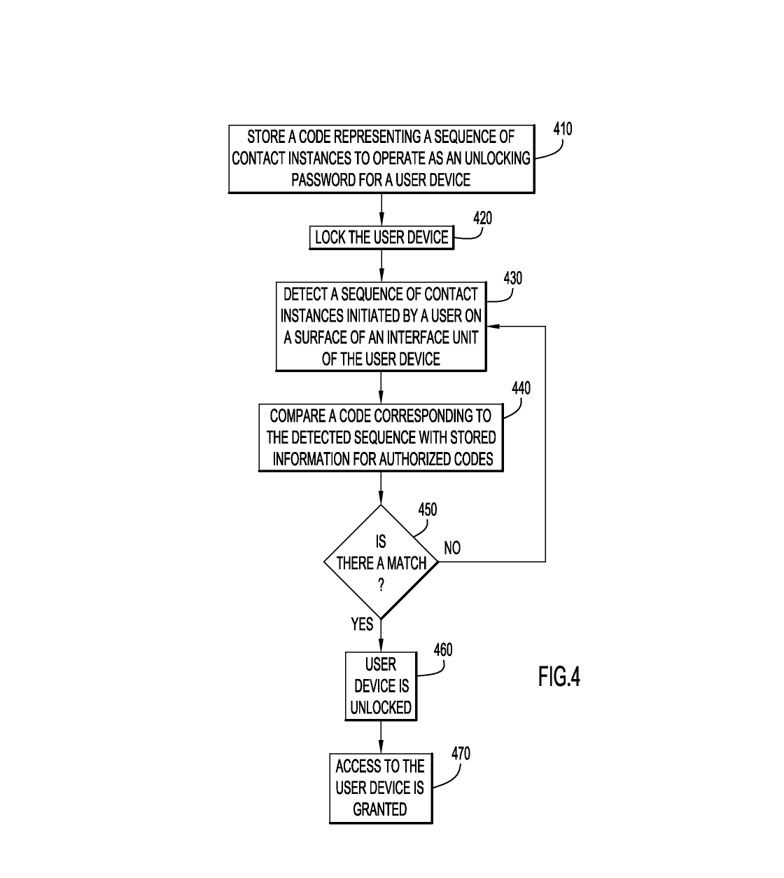

Reference is now made to FIG. 4, which shows a flow chart depicting the unlocking operations of the contact detection and sequence matching logic 300. At 410, a code is stored representing a sequence of contact instances to operate as an unlocking password for the user device 100. For example, as described above, the user 130 may enter a series of touches on the interface unit 110 to serve as the unlock sequence for the user device 100. A code representing the unlock sequence or password is stored, and the user device 100, at 420, is locked. For example, operation 420 may comprise restricting access to an operating system or to other applications/operations hosted by the user device 100. In the example where the user device 100 is a mobile device, operation 420 is performed to restrict user access to an operating system and application of the mobile device. Also, as described above, the user device 100 may be a vault, safe, etc. In this example, operation 420 is performed to restrict user access to the contents of the vault, safe, etc (e.g., the user 130 is restricted from utilizing the interface unit 110 of the user device 100 to gain access to the vault, safe, etc. unless a proper unlock sequence is detected).

At 430, when a user desires to access the user device 100 (or to a device or system associated with the user device), the user 130 makes a sequence of contact instances that are detected on the surface of the interface unit 110. A code corresponding to the detected sequence is compared, at 440, to stored information for authorized codes, as described above. At 450, a determination is made as to whether there is a match between the code corresponding to the detected sequence and the stored information for authorized codes. If there is a match, the user device 100 is unlocked at 460, and access to the user device 100 (or to a device or system associated with the user device 100) is granted at 470. If there is not a match (e.g., if the answer to decision 450 is “no), another sequence of contact instances is detected, as described by operation 430, above.

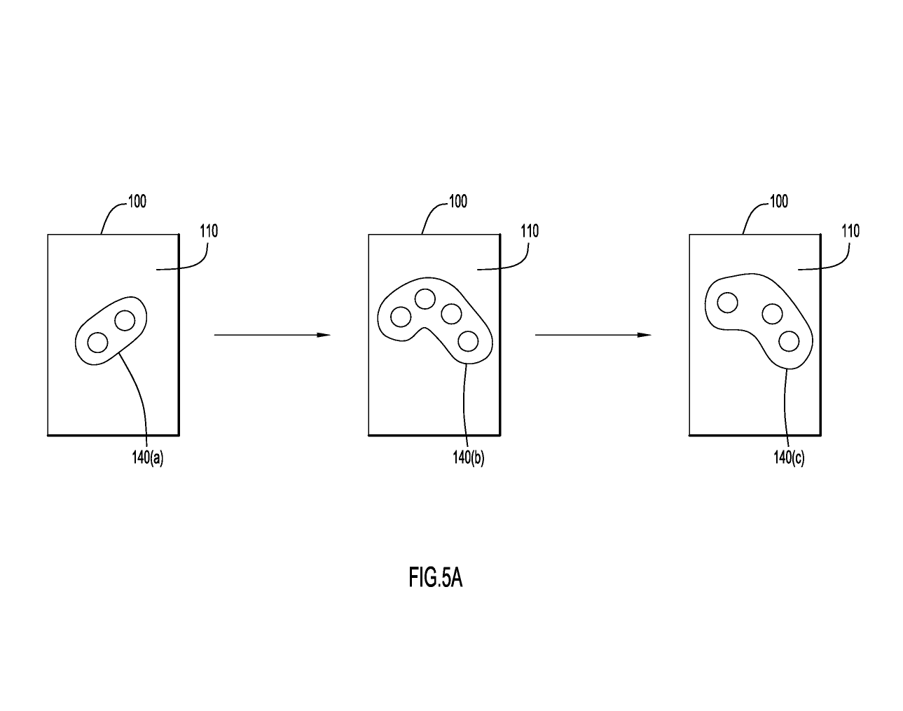

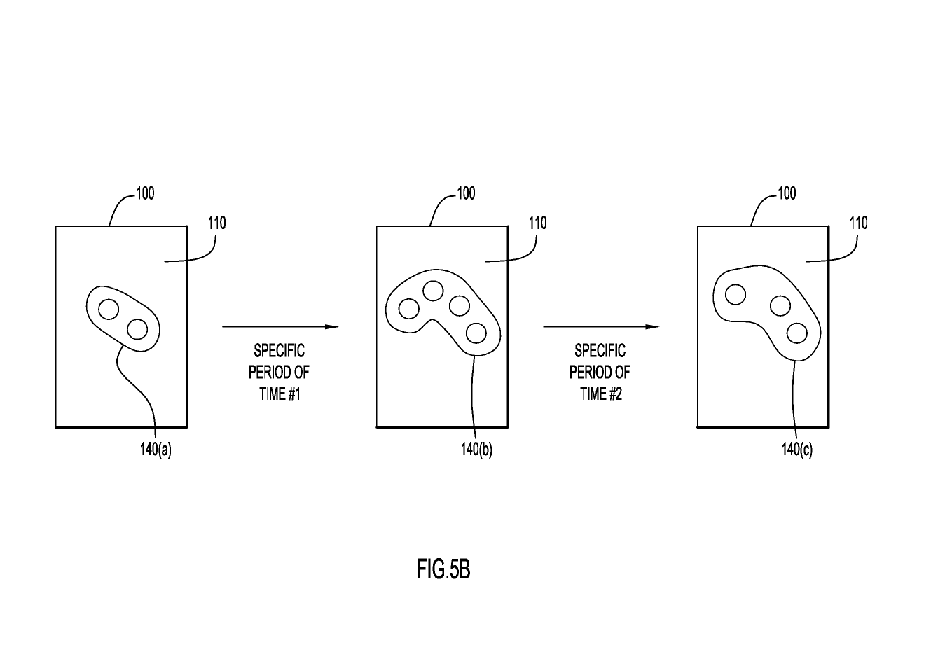

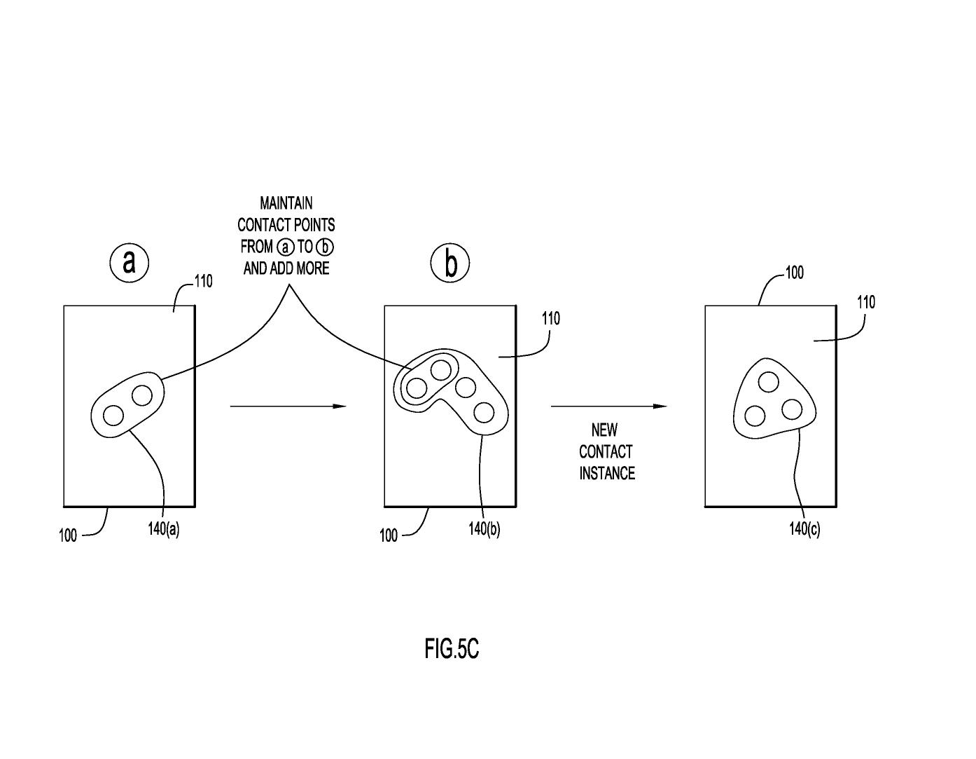

Reference is now made to FIGS. 5A-5C. FIGS. 5A-5C show example embodiments of sequences of contact instances that may be initiated by the user 130 and/or that may be used as the unlock sequence, described above. FIG. 5A shows an example of a “touch sequence,” FIG. 5B shows an example of a “rhythm sequence,” and FIG. 5C shows an example of an “add sequence.” These sequences differ from one another based on how the contact instances in each sequence are generated/initiated by the user 130, as described herein. The sequences described in FIGS. 5A-5C allow for the user device 100 to be unlocked without revealing the appropriate unlock sequence that is used to unlock the user device 100. For example, by utilizing the techniques described herein, an unauthorized party cannot examine grease marks left on surfaces of the interface device 110 to determine the specific unlock sequence. Additionally, the techniques described herein would enable a visually impaired user to unlock the user device 100.

In FIG. 5A, the user 130 initiates a set of three contact instances. The first contact instance, shown at reference numeral 140(a), comprises two touches between the user 130 and the interface unit 110 of the user device 100. For example, the user 130 may place touch two fingers simultaneously (or nearly simultaneously) to the surface of the interface unit 110 to create contact instance 140(a). The second contact instance, shown at reference numeral 140(b), comprises four touches between the user 130 and the interface unit 110. For example, after contact instance 140(a) is created, the user 130 may lift the two fingers used to create the first contact instance 140(a) and then may touch four fingers to the surface of the interface unit 110 to create contact instance 140(b). The third contact instance, shown at reference numeral 140(c), comprises three touches between the user 130 and the interface unit 110. As is the case above, the user may lift the four fingers used to create the second contact instance 140(b) and then may touch three fingers to the surface of the interface unit 110 to create contact instance 140(c). Thus, the sequence of contact instances 140(a)-140(c) shown in FIG. 5A represents a “2-4-3 touch sequence” of contact instances.

As stated above, the user 130 may initiate the sequence of contact instances 140(a)-140(c) to establish the 2-4-3 sequence as the unlock sequence for the user device 100. After the user device 100 is locked, the user 130 may regain access to the user device 100 by entering the 2-4-3 sequence on the surface of the interface unit 110.

In FIG. 5B, the user 130 also initiates a set of three contact instances. Similar to FIG. 5A, the first contact instance 140(a) comprises two touches, the second contact instance 140(b) comprises four touches, and the third contact instance 140(c) comprises three touches between the user 130 and the surface of the interface unit 110. However, in contrast to FIG. 5A, each of the contact instances 140(a)-140(c) comprise a series of touches between the user 130 and the surface of the interface unit 110. For example, the user 130 may touch one finger (or, e.g., stylus or other touch device) on the surface of the interface unit 110 two times within a first predetermined period of time to create contact instance 140(a) instead of touching two fingers simultaneously. Similarly, within a second predetermined period of time, the user 130 may touch one finger on the surface of the interface unit 110 four times to create contact instance 140(b) and may touch one finger on the surface of the interface unit 110 three times to create contact instance 140(c). Thus, FIG. 5B shows a “2-4-3 rhythm sequence” of contact instances 140(a)-140(c), where each contact instance is generated by a series of repeated touches within the predetermined periods of time for each contact instance.

FIG. 5C also shows a set of three contact instances 140(a)-140(c), as shown in FIGS. 5A and 5B. In FIG. 5C, the first contact instance 140(a) may be generated in a manner similar to the techniques described in FIG. 5A (e.g., two fingers touching the surface of the interface unit 110). The second contact instance 140(b), however, is generated by maintaining the first contact instance 140(a) on the surface of the interface unit 110, while adding additional points of contact on the surface of the interface unit 110.

For example, a first one of the contact instances (e.g., contact instance 140(a)) may comprise one or more points of contact between the user 130 and the surface of the interface unit 110. A second one of the contact instances (e.g., contact instance 140(b)) may comprise adding one or more points of contact between the user 130 and the surface of the interface unit 110 while maintaining the one or more points of contact between the user 130 and the surface of the interface unit that occurs during the first one of the contact instances.

In the example shown in FIG. 5C, the user 130 may touch two fingers to the surface of the interface unit 110 to generate the first contact instance 140(a). In order to generate the second contact instance 140(b), the user 130 may continue to touch the two fingers used to generate contact instance 140(a) to the interface unit 110 and then may touch two additional fingers to create contact instance 140(b). That is, contact instance 140(a) may be a subset of contact instance 140(b). The two additional fingers may touch the interface unit 110 in a manner described in FIG. 5A or 5B, above. The user 130 may then lift the fingers contacting the interface unit 110 and may initiate a third contact instance 140(c) in a manner described above with respect to FIG. 5A or 5B. Thus, FIG. 5C shows a “2-4-3 add sequence” of contact instances 140(a)-140(c).

Though contact instance 140(b) in FIG. 5C consists of adding points of contact to a previous contact instance (e.g., contact instance 140(a)), it should be appreciated that contact instances can also be created by removing points of contact from previous contact instances. For example, if a first contact instance comprises three touches (e.g., the user 130 touching three fingers to the surface of the interactive device 110), the second contact instance comprising two touches can be generated by lifting one finger from the surface of the interface unit 110, while maintaining the other two fingers touching the surface of the interface unit 110.

In one example, a first contact instance may comprise one or more points of contact between the user 130 and the surface of the interface unit 110, and the second contact instance may comprise removing one or more points of contact between the user 130 and the surface of the interface unit 110 that occurs during the first contact instance.

It should be appreciated that in the sequences described above in FIGS. 5A-5C, the user 130 can make points of contact anywhere on the surface of the interface unit 110 so long as the interface unit 110 can recognize the point of contact. This allows the user 130 to quickly enter the unlock sequence without having to look at the surface of the interface unit 110.

As described above, the user device 100, in addition to detecting contact instances, may also be configured to detect interaction instances. For example, the user 130 may establish an unlock sequence or may actually unlock the user device 100 without physically touching the surface of the interface unit 110. Instead, the user 130 may gesture or imitate/simulate a touch within a sufficient proximity to the surface of the interface unit 110. In these instances, the interface unit 110 can detect the gesture or simulated touch (e.g., a “point of activation”) and may compare sequences of multiple points of activations to codes representing the unlock sequence. It should be appreciated that the “touch sequence,” “rhythm sequence” and “add sequence” described above in connection with FIGS. 5A-5C can be applied for initiating and detecting interaction instances between the user 130 and the interface unit 110.

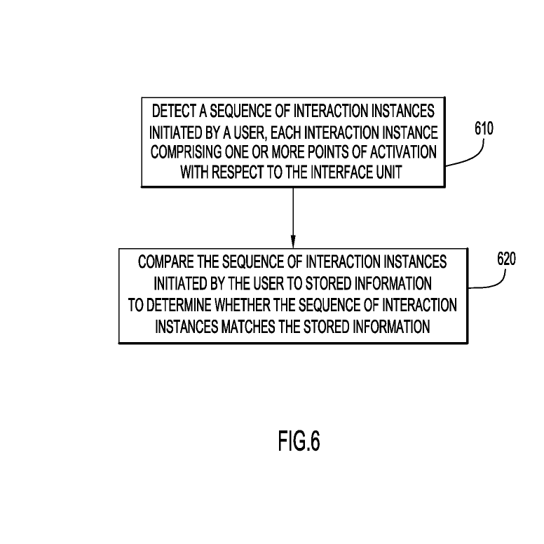

Reference is now made to FIG. 6, which shows a flow chart depicting the comparison operations of the contact detection and sequence matching logic 300 for detecting interaction instances. At 610, a sequence of interaction instances is initiated by the user 130. Each of the interaction instances comprise one or more points of activation (e.g., gestured or simulated touches) between the user 130 and the surface of the interface unit 110. At 620, the sequence of interaction instances initiated by the user 130 is compared to stored information to determine whether the sequence of interaction instances matches the stored information. This comparison is used to determine whether the detected sequence of interaction instances matches the stored information.

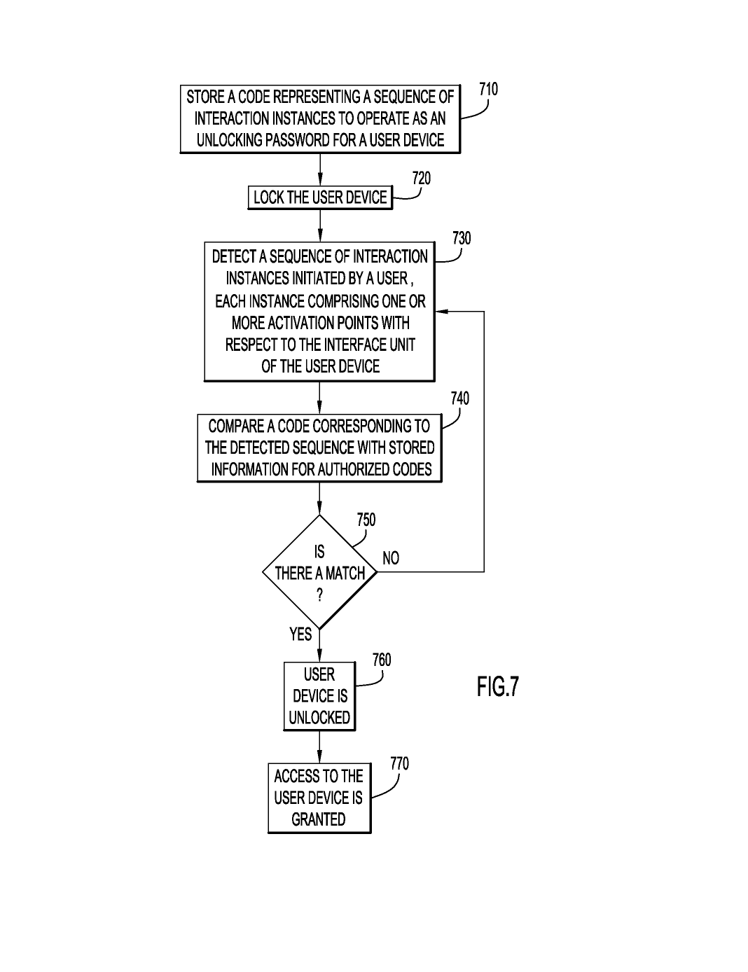

Reference is now made to FIG. 7, which shows a flow chart depicting the unlocking operations of the contact detection and sequence matching logic 300. At 710, a code is stored representing a sequence of interaction instances to operate as an unlocking (security) password for the user device 100. At 720, the user device 100 is locked, as described above in connection with FIG. 4. After the user device 100 is locked, a user may attempt to unlock the device by entering a sequence of interaction instances which are detected, at 730, on the surface of the interface unit 110. A code corresponding to the detected sequence is compared, at 740, to stored information for authorized codes, as described above. At 750, a determination is made as to whether there is a match between the code corresponding to the detected sequence and the stored information for authorized codes. If there is a match, the user device 100 is unlocked at 760, and access to the user device 100 is granted at 770. If there is not a match, another sequence of interaction instances is detected, as described above by operation 730, above.

In sum, a method is provided comprising: at an interface unit of a user device, detecting a sequence of contact instances initiated by a user on a surface of the interface unit, wherein each contact instance comprises one or more points of contact between the user and the surface of the interface unit; and comparing the sequence of contact instances initiated by the user to stored information to determine whether the sequence of contact instances matches the stored information.

In addition, a method is provided comprising: at an interface unit of a user device, detecting a sequence of interaction instances initiated by a user, wherein each interaction instance comprises one or more points of activation with respect to the interface unit; and comparing the sequence of interaction instances initiated by the user to stored information to determine whether the sequence of interaction instances matches the stored information.

Furthermore, one or more computer readable storage media is provided that is encoded with software comprising computer executable instructions and when the software is executed operable to: detect a sequence of contact instances initiated by a user on a surface of a interface unit of a user device, wherein each contact instance comprises one or more points of contact between the user and the surface of the interface unit; and compare the sequence of contact instances initiated by the user to stored information to determine whether the sequence of contact instances matches the stored information.

Additionally, one or more computer readable storage media is provided that is encoded with software comprising computer executable instructions and when the software is executed operable to: detect a sequence of interaction instances initiated by a user, wherein each interaction instance comprises one or more points of activation with respect to an interface unit of a user device; and compare the sequence of interaction instances initiated by the user to stored information to determine whether the sequence of interaction instances matches the stored information.

Furthermore, an apparatus is provided comprising: an interface unit; a memory; and a processor coupled to the memory and the interface unit, wherein the processor is configured to: detect a sequence of contact instances initiated by a user on a surface of a interface unit of a user device, wherein each contact instance comprises one or more points of contact between the user and the surface of the interface unit; and compare the sequence of contact instances initiated by the user to stored information to determine whether the sequence of contact instances matches the stored information.

In addition, an apparatus is provided comprising: an interface unit; a memory; a proximity sensor; and a processor coupled to the interface unit, the memory and the proximity device, wherein the processor is configured to: detect via the proximity sensor a sequence of interaction instances initiated by a user, wherein each interaction instance comprises one or more points of activation with respect to the interface unit; and compare the sequence of interaction instances initiated by the user to stored information to determine whether the sequence of interaction instances matches the stored information.

The above description is intended by way of example only.

What is claimed is:

1. A method comprising:
at an interface unit of a user device, detecting a sequence of contact instances initiated by a user on a surface of the interface unit, wherein each contact instance comprises one or more points of contact between the user and the surface of the interface unit; and
comparing the sequence of contact instances initiated by the user to stored information to determine whether the sequence of contact instances matches the stored information.

2. The method of claim 1, further comprising granting access to the user device or to a device or system associated with the user device when the sequence of contact instances matches the stored information.

3. The method of claim 1, wherein detecting comprises detecting each of the one or more contact instances such that the one or more points of contact for each of the contact instances occur simultaneously.

4. The method of claim 1, wherein detecting comprises detecting each of the one or more contact instances such that the one or more points of contact for each of the contact instances occur within a predetermined amount of time.

5. The method of claim 1, wherein detecting comprises detecting a first contact instance and a second contact instance, wherein the first contact instance comprises one or more points of contact between the user and the surface of the interface unit and wherein the second contact instance comprises one or more points of contact between the user and the surface of the interface unit added while the one or more points of contact between the user and the surface of the interface unit during the first contact instance are maintained.

6. The method of claim 1, wherein detecting comprises detecting a first contact instance and a second contact instance, wherein the first contact instance comprises one or more points of contact between the user and the surface of the interface unit and wherein the second contact instance comprises removal of one or more points of contact between the user and the surface of the interface unit that occurs during the first contact instance.

7. The method of claim 1, wherein detecting comprises detecting the sequence of contact instances at any location on the surface of the interface user device.

8. The method of claim 1, wherein detecting comprises detecting the sequence of contact instances within a predetermined period of time.

9. The method of claim 1, wherein detecting comprises detecting the contact instances in the form of touches on a surface of the interface unit.

10. A method comprising:
at an interface unit of a user device, detecting a sequence of interaction instances initiated by a user, wherein each interaction instance comprises one or more points of activation with respect to the interface unit; and
comparing the sequence of interaction instances initiated by the user to stored information to determine whether the sequence of interaction instances matches the stored information.

11. The method of claim 10, wherein detecting comprises detecting the sequence of interactions instances initiated by the user, wherein each interaction instance simulates points of contact between the user and the interface unit.

12. The method of claim 10, further comprising granting access to the user device or to a device or system associated with the user device when the sequence of interaction instances matches the stored information.

13. One or more computer readable storage media encoded with software comprising computer executable instructions and when the software is executed operable to:
detect a sequence of contact instances initiated by a user on a surface of a interface unit of a user device, wherein each contact instance comprises one or more points of contact between the user and the surface of the interface unit; and
compare the sequence of contact instances initiated by the user to stored information to determine whether the sequence of contact instances matches the stored information.

14. The computer readable storage media of claim 13, further comprising instructions operable to grant access to the user device or to a device or system associated with the user device when the sequence of contact instances matches the stored information.

15. The computer readable storage media of claim 13, wherein the instructions that are operable to detect comprise instructions that are operable to detect each one of the one or more contact instances such that the one or more points of contact for each of the contact instances occur simultaneously.

16. The computer readable storage media of claim 13, wherein the instructions that are operable to detect comprise instructions that are operable to detect each one of the one or more contact instance such that the one or more points of contact for each of the contact instances occur within a predetermined amount of time.

17. The computer readable storage media of claim 13, wherein the instructions that are operable to detect comprise instructions that are operable to detect a first contact instance and a second contact instance, wherein the first contact instance comprises one or more points of contact between the user and the surface of the interface unit and wherein the second contact instance comprises one or more points of contact between the user and the surface of the interface unit added while the one or more points of contact between the user and the surface of the interface unit during the first contact instance are maintained.

18. The computer readable storage media of claim 13, wherein the instructions that are operable to detect comprise instructions that are operable to detect a first contact instance and a second contact instance, wherein the first contact instance comprises one or more points of contact between the user and the surface of the interface unit and wherein the second contact instance comprises removal of one or more points of contact between the user and the surface of the interface unit that occurs during the first contact instance.

19. One or more computer readable storage media encoded with software comprising computer executable instructions and when the software is executed operable to:
detect a sequence of interaction instances initiated by a user, wherein each interaction instance comprises one or more points of activation with respect to an interface unit of a user device; and
compare the sequence of interaction instances initiated by the user to stored information to determine whether the sequence of interaction instances matches the stored information.

20. The computer readable storage media of claim 19, wherein the instructions that are operable to detect comprise instructions that are operable to detect the sequence of interaction instances initiated by the user, wherein each interaction instance simulates points of contact between the user and the interface unit.

21. An apparatus, comprising:
an interface unit;
a memory; and
a processor coupled to the memory and the interface unit and configured to:
detect a sequence of contact instances initiated by a user on a surface of a interface unit of a user device, wherein each contact instance comprises one or more points of contact between the user and the surface of the interface unit; and
compare the sequence of contact instances initiated by the user to stored information to determine whether the sequence of contact instances matches the stored information.

22. The apparatus of claim 21, wherein the processor is further configured to grant access to the user device when the sequence of contact instances matches the stored information.

23. An apparatus comprising:
an interface unit;
a memory;
a proximity sensor; and
a processor coupled to the interface unit, the memory and the proximity device and configured to:
detect via the proximity sensor a sequence of interaction instances initiated by a user, wherein each interaction instance comprises one or more points of activation with respect to the interface unit; and
compare the sequence of interaction instances initiated by the user to stored information to determine whether the sequence of interaction instances matches the stored information.

24. The apparatus of claim 23, wherein the processor is further configured to detect the sequence of interaction instances initiated by the user, wherein each interaction instance simulates points of contact between the user and the interface unit.
